(19) United States
(12) Patent Application Publication
(10) Pub. No.: US 2025/0214357 A1
(43) Pub. Date: Jul. 3, 2025

(54) PRINTING APPARATUS

(71) Applicant: SEIKO EPSON CORPORATION, Tokyo (JP)

(72) Inventor: Shuhei KUROTOBI, MATSUMOTO-SHI (JP)

(21) Appl. No.: 19/001,796

(22) Filed: Dec. 26, 2024

(30) Foreign Application Priority Data
Dec. 27, 2023 (JP) 2023-221180

(51) Int. Cl. B41J 15/16; B41J 15/04

(52) U.S. Cl. CPC B41J 15/16; B41J 15/04

(57) ABSTRACT

A printing apparatus includes a printing unit configured to perform printing on a medium, a winding unit configured to support a paper tube in an axial line direction of the paper tube, and wind the medium into a roll shape, a stay being provided to extend in an extension direction in which the winding unit supports the paper tube and being configured to support the winding unit in a support direction intersecting with a vertical direction and the extension direction, and a medium reception unit being held by the stay and being configured to receive a roll body of the medium wound into a roll shape, the roll body being to be removed from the winding unit, wherein the medium reception unit includes a medium placement portion that protrudes in the support direction, and the medium placement portion is configured so that the roll body is placed thereon.

The present application is based on, and claims priority from JP Application Serial Number 2023-221180, filed Dec. 27, 2023, the disclosure of which is hereby incorporated by reference herein in its entirety.

### BACKGROUND

### 1. Technical Field

The present disclosure relates to a printing apparatus.

### 2. Related Art

Hitherto, various types of printing apparatuses have been used. Among those, there is a printing apparatus including a printing unit that performs printing on a medium, and a winding unit that sandwiches a paper tube, around which a medium is wound, in an axial line direction, supports the paper tube, and winds the medium into a roll shape. For example, JP-A-2016-203390 discloses a printing apparatus including a printing unit that performs printing on a medium, and a winding unit that sandwiches a paper tube, around which a medium is wound by a holding unit, in an axial line direction, supports the paper tube, and winds the medium into a roll shape.

In the related-art printing apparatus including the printing unit and the winding unit that are configured as in the printing apparatus in JP-A-2016-203390, a rail-like stay that enables movement of the winding unit in a width direction is generally provided below the winding unit so that the paper tube around which the medium is wound or the like is sandwiched from both sides in the width direction corresponding to the axial line direction of the paper tube. However, with this configuration, the printing apparatus tends to be increased in a height direction. Thus, the arrangement of the winding unit with respect to the stay is changed from a substantially vertical direction to a substantially horizontal direction so as to suppress the height of the printing apparatus. In such a case, a space where an operation of removing a roll body being the medium wound into a roll shape is executed is reduced, and the operation tends to be difficult.

### SUMMARY

In order to solve the above-mentioned problem, a printing apparatus of the present disclosure includes a printing unit configured to perform printing on a medium, a winding unit configured to support a paper tube around which the medium is wound, so as to sandwich the paper tube in an axial line direction of the paper tube, and configured to wind the medium, a stay provided to extend in an extension direction parallel to the axial line direction in which the winding unit supports the paper tube and configured to support the winding unit in a support direction intersecting with a vertical direction and the extension direction, and a medium reception unit held by the stay and configured to receive a roll body of the medium wound into a roll shape, the roll body being configured to be removed from the winding unit, wherein the medium reception unit includes a medium placement portion protruding in the support direction, and the medium placement portion is configured to allow the roll body to be placed thereon.

### BRIEF DESCRIPTION OF THE DRAWINGS

FIG. 1 is a schematic side cross-sectional view of a printing apparatus according to an embodiment of the present disclosure.

FIG. 2 is a side view of a periphery of a winding unit of the printing apparatus in FIG. 1.

FIG. 3 is a front view of the periphery of the winding unit of the printing apparatus in FIG. 1.

FIG. 4 is a perspective view of a periphery of a medium reception unit attached to the printing apparatus in FIG. 1.

FIG. 5 is a side view of the medium reception unit that can be attached to the printing apparatus in FIG. 1.

FIG. 6 is a side cross-sectional view of the periphery of the medium reception unit, for describing a use method for the medium reception unit attached to the printing apparatus in FIG. 1.

FIG. 7 is a side view of a medium reception unit configured differently from the medium reception unit illustrated in FIG. 2 to FIG. 6, a medium reception unit being attachable to the printing apparatus in FIG. 1.

FIG. 8 is a side view of a periphery of a winding unit of a printing apparatus in a reference example.

FIG. 9 is a front view of the periphery of the winding unit of the printing apparatus in the reference example in FIG. 8.

### DESCRIPTION OF EMBODIMENTS

First, the present disclosure is schematically described.

In order to solve the above-mentioned problem, a printing apparatus of a first aspect of the present disclosure includes a printing unit configured to perform printing on a medium, a winding unit configured to support a paper tube around which the medium is wound, so as to sandwich the paper tube in an axial line direction of the paper tube, and configured to wind the medium, a stay provided to extend in an extension direction parallel to the axial line direction in which the winding unit supports the paper tube and configured to support the winding unit in a support direction intersecting with a vertical direction and the extension direction, and a medium reception unit held by the stay and configured to receive a roll body of the medium wound into a roll shape, the roll body being to be removed from the winding unit, wherein the medium reception unit includes a medium placement portion protruding in the support direction, and the medium placement portion is configured to allow the roll body to be placed thereon.

According to the aspect, the stay that supports the winding unit in the support direction intersecting with the vertical direction is provided. Thus, arrangement of the winding unit with respect to the stay can be changed from substantially the vertical direction to substantially the horizontal direction, and thus the height of the printing apparatus can be suppressed. Further, the medium reception unit that receives the roll body is held by the stay, the medium reception unit includes the medium placement portion that protrudes in the support direction, and the roll body can be placed on the medium placement portion. Thus, when the roll body is removed from the winding unit, the roll body can be placed temporarily on the medium placement portion of the medium reception unit. Further, the medium reception unit is held by the stay. Thus, in this state, a movement distance of the roll body is short, and the roll body can easily be placed on the medium placement portion. Therefore, the burden of work for removing the roll body can be alleviated while suppressing an increase in size of the printing apparatus.

A printing apparatus of a second aspect of the present disclosure is an aspect dependent on the first aspect, wherein the medium reception unit includes an engagement portion engaged with the stay and an intermediate portion arranged between the engagement portion and the medium placement portion.

According to the aspect, the medium reception unit includes the engagement portion being engaged with the stay and the intermediate portion being arranged between the engagement portion and the medium placement portion. With this configuration, the medium reception unit configured so that the roll body can easily be placed on the medium placement portion can be achieved.

A printing apparatus of a third aspect of the present disclosure is an aspect dependent on the second aspect, wherein the engagement portion and the intermediate portion are coupled to be turnable about an axis parallel to the extension direction, and the intermediate portion and the medium placement portion are coupled to be turnable about an axis parallel to the extension direction.

According to the aspect, the engagement portion and the intermediate portion are coupled to be turnable about an axis parallel to the extension direction, and the intermediate portion and the medium placement portion are coupled to be turnable about an axis parallel to the extension direction. With this configuration, when the roll body is placed on the medium placement portion, the medium placement portion can be arranged suitably. Moreover, when the roll body is not placed on the medium placement portion, the medium placement portion can be arranged at a position that does not interfere with a worker.

A printing apparatus of a fourth aspect of the present disclosure is an aspect dependent on the second aspect, wherein the intermediate portion is formed of a flexible member.

According to the aspect, the intermediate portion is formed of a flexible member. With this configuration, a strong force can be deflected when the force is applied to the medium reception unit, and damage of the medium reception unit can be suppressed.

A printing apparatus of a fifth aspect of the present disclosure is an aspect dependent on any one of the first to fourth aspects, wherein the medium reception unit is configured to move in the extension direction with respect to the stay.

According to the aspect, the medium reception unit is configured to move in the extension direction with respect to the stay. With this configuration, the medium reception unit can be arranged with respect to the stay according to the medium with various widths (lengths in the axial line direction), and the burden of work for removing the roll body can be alleviated.

A printing apparatus of a sixth aspect of the present disclosure is an aspect dependent on any one of the first to fourth aspects, wherein the medium reception unit is engaged with the stay from the vertical direction.

According to the aspect, the medium reception unit is engaged with the stay from the vertical direction. With this configuration, the medium reception unit can be attached easily and securely to the stay.

A printing apparatus of a seventh aspect of the present disclosure is an aspect dependent on any one of the first to fourth aspects, wherein a length of the medium placement portion in the support direction is configured to be changed.

According to the aspect, the length of the medium placement portion in the support direction is configured to be changed. With this configuration, the length of the medium placement portion in the support direction can be changed suitably according to the roll body with various winding diameters to support the roll body with various winding diameters.

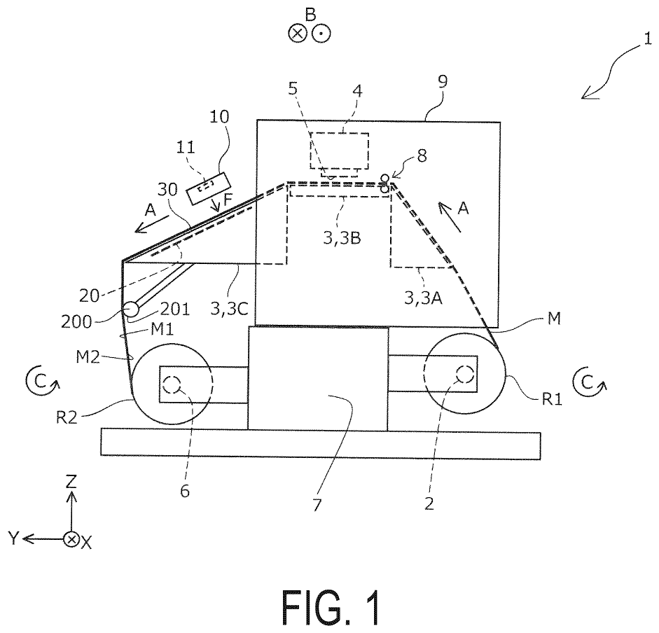

With reference to the drawings, an embodiment according to the present disclosure is specifically described below. First, with reference to FIG. 1, an overview of a printing apparatus 1 according to an embodiment of the present disclosure is described. Note that, in FIG. 1, some constituent members are simplified and omitted for easy understanding of the configuration. Herein, in FIG. 1, in the accompanying drawings, an X-axis direction is a horizontal direction and a direction in which a support portion of a supply unit 2 extends. The supply unit 2 holds a roll body R1 obtained by winding a medium M into a roll shape. A Y-axis direction is a horizontal direction, a front-and-rear direction of the printing apparatus 1, and a direction orthogonal to the X-axis direction. A Z-axis direction is a vertical direction. Further, hereinafter, it is assumed that an arrow direction is a + direction, and a direction opposite to the arrow direction is a − direction. For example, in FIG. 1, it is assumed that a vertically upward direction is a +Z-direction, a vertically downward direction is a −Z-direction, a forward direction of the printing apparatus 1 is a +Y-direction, and a rearward direction of the printing apparatus 1 is a −Y-direction.

As illustrated in FIG. 1, the printing apparatus 1 of the embodiment includes a main body unit 9. A leg frame 7 is attached to the periphery of both the ends of the main body unit 9 in the X-axis direction. Further, the printing apparatus 1 of the embodiment includes the supply unit 2 on the −Y side being a rear side of the main body unit 9. The supply unit 2 holds the roll body R1. The supply unit 2 sandwiches and supports a paper tube of the roll body R1, which is obtained by winding the medium M, in the X-axis direction, and supplies the medium M to a head 5 being a printing unit.

Further, In the printing apparatus 1 of the embodiment, when the medium M is transported in the transport direction A, the supply unit 2 rotates the roll body R1 in a rotation direction C. Note that, in FIG. 1, the roll body R1 wound so that an image forming surface M1 on which an image is formed is on the outer side is used. However, when the roll body R1 wound so that the image forming surface M1 is on the inner side is used, the supply unit 2 can rotate the roll body R1 in a direction opposite to the rotation direction C to feed the medium M.

Further, the printing apparatus 1 of the embodiment includes a transport path of the medium M. The transport path includes a medium support portion 3 that supports the medium M on a support surface 30. The printing apparatus 1 according to the embodiment includes, as the medium support portion 3, an upstream medium support portion 3A, a medium support portion 3B, and a downstream medium support portion 3C from the upstream to the downstream in the transport direction A. The printing apparatus 1 further includes a roller pair 8 including a driving roller and a driven roller as a transport unit for transporting the medium M in the transport direction A on the transport path. However, the configuration of the transport unit is not specifically limited.

Further, the printing apparatus 1 of the embodiment includes a head 5 and a carriage 4 at a position facing the medium support portion 3B. The head 5 is a printing unit that is provided with a plurality of nozzles and forms an image by ejecting ink being a liquid from the nozzles. The carriage 4 is mounted with the head 5 and is reciprocally movable in a width direction B. Note that, in the printing apparatus 1 of the embodiment, the transport direction A at a position facing the head 5 on the medium support portion 3B is the +Y direction, the width direction B, which is the moving direction of the head 5, is the direction along the X-axis direction, and the ejecting direction of ink is the −Z direction.

With the configuration described above, the head 5 is configured to form an image by ejecting ink from the nozzles (not illustrated) onto a transported medium, while the head 5 reciprocates in the width direction B as a direction intersecting with the transport direction A. The printing apparatus 1 of the present exemplary embodiment is configured to form a desired image on the medium M by repeating transport of the medium M by a predetermined transport amount in the transport direction A and ejection of ink in a state in which the medium M is stopped while the head 5 moves in the width direction B.

Further, the downstream medium support portion 3C of the medium support portions 3 is provided with a heater 20 as a heating unit for heating a supported surface M2 opposite to an image forming surface M1 of the medium M. The heater 20 according to the embodiment is constituted by an electric heating wire and the like but is not limited to such a configuration. Further, not only the downstream medium support portion 3C but also the upstream medium support portion 3A and the medium support portion 3B may be provided with a medium heating unit that heats the supported surface M2 opposite to the image forming surface M1 of the medium M.

Further, an air blowing unit 10 that dries the ink ejected from the head 5 to the image forming surface M1 of the medium M by blowing an airflow F is provided in a portion facing the downstream medium support portion 3C in the transport path. The air blowing unit 10 of the present embodiment includes a fan 11 that generates an airflow F, and is configured to blow a gas as the airflow F to the image forming surface M1 of the medium M, but is not limited to such a configuration.

Further, a winding unit 6 is provided downstream of the downstream medium support portion 3C in the transport direction A. The winding unit 6 winds the medium M transported in the transport direction A into a roll shape to obtain a roll body R2. Note that, in the printing apparatus 1 of the embodiment, the supply unit 2 and the winding unit 6 are similarly configured. The medium M transported from the supply unit 2 to the winding unit 6 is transported while a predetermined tension is applied thereto by the winding unit 6 or the like. The winding unit 6 sandwiches a paper tube of a winding core of the roll body R2 in the X-axis direction, supports the paper tube, and winds the medium M into a roll shape by rotating the paper tube. In FIG. 1, when the winding unit 6 rotates the roll body R2 in the rotation direction C, winding is performed so that the image forming surface M1 faces outward. However, the medium M may be wound so that the image forming surface M1 faces inward. In such a case, the winding unit 6 rotates the roll body R2 in a direction opposite to the rotation direction C.

Note that a guide bar 200 is provided between the downstream medium support portion 3C and the winding unit 6 in the transport direction A. The guide bar 200 includes a contact surface 201 having an arc shape as viewed in the width direction B. Further, the contact surface 201 contacts with the supported surface M2 of the medium M wound by the winding unit 6. With this, the guide bar 200 guides transport of the medium M. However, the configuration of the guide bar 200 is not particularly limited, and a configuration without the guide bar 200 may be adopted.

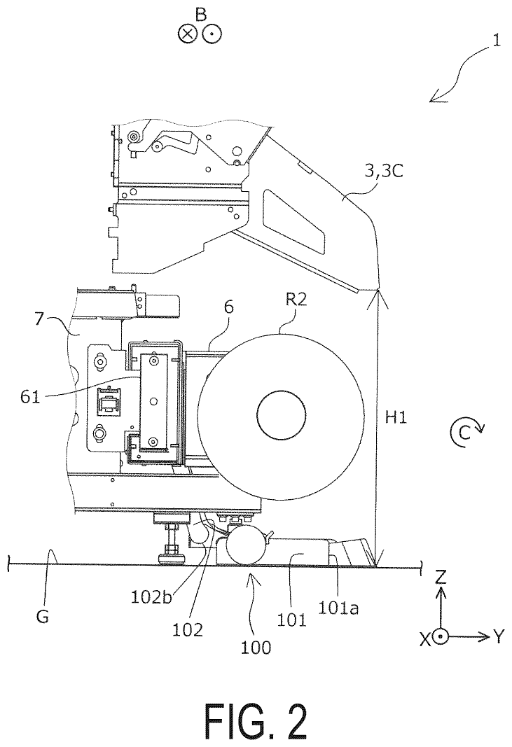

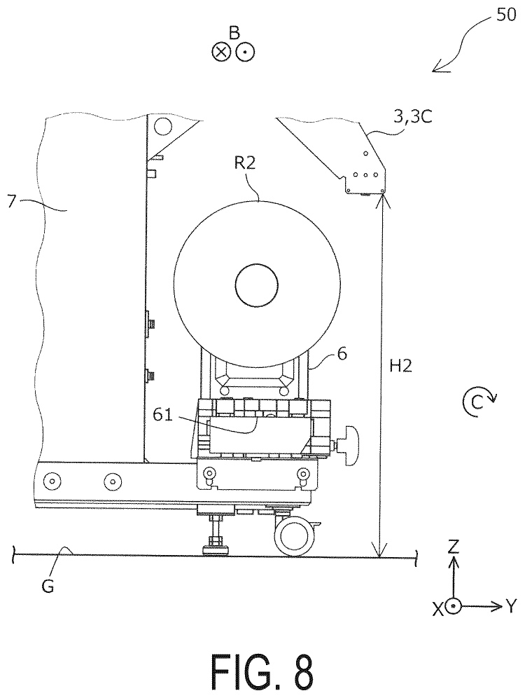

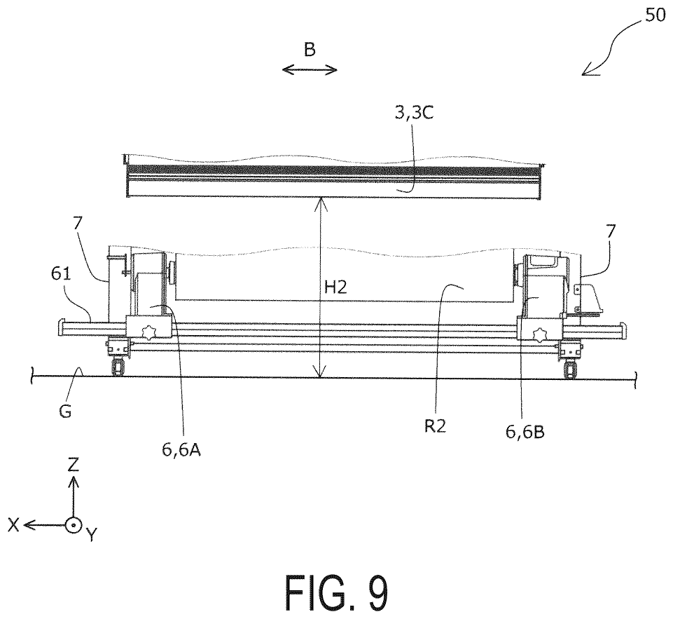

As described above, the printing apparatus 1 of the embodiment includes the head 5 that performs printing on the medium M, and the winding unit 6 that sandwiches the paper tube, around which the medium M is wound, in the X-axis direction corresponding to an axial line direction of the paper tube, supports the paper tube, and winds the medium M. A method of removing the roll body R2 of the medium M wound by the winding unit 6 of the printing apparatus 1 of the embodiment, and a configuration thereof are described below with reference to FIG. 2 to FIG. 7, with comparison with FIG. 8 and FIG. 9 illustrating a printing apparatus 50 in a reference example, as required.

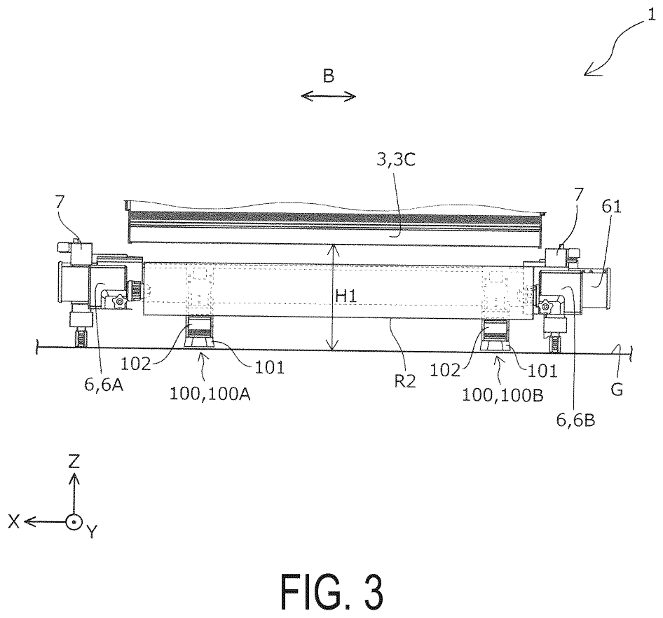

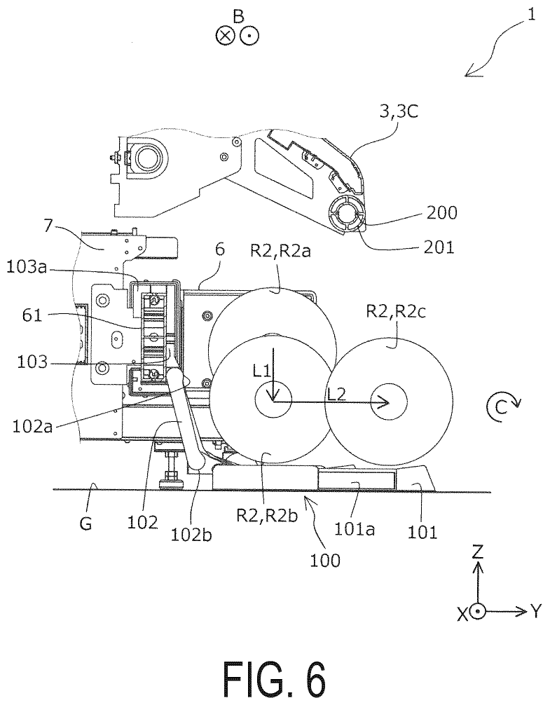

As illustrated in FIG. 2, FIG. 3, FIG. 6, and the like, the printing apparatus 1 of the embodiment includes a stay 61 that is provided to extend in an extension direction parallel to the X-axis direction being an axial line direction in which the winding unit 6 supports the paper tube of the roll body R2. Further, the stay 61 supports the winding unit 6 in a support direction (the Y-axis direction) intersecting with the vertical direction (the Z-axis direction) and the extension direction (the X-axis direction). Thus, in the printing apparatus 1 of the embodiment, the winding unit 6 is arranged substantially the horizontal direction, instead of substantially the vertical direction, with respect to the stay 61, and hence height of the printing apparatus 1 can be suppressed.

Further, as illustrated in FIG. 2, FIG. 3, FIG. 6, and the like, in the printing apparatus 1 of the embodiment, a medium reception unit 100 is held by the stay 61. The medium reception unit 100 can receive the roll body R2 of the medium that is wound into a roll shape and is removed from the winding unit 6. Herein, the medium reception unit 100 includes a medium placement portion 101 that protrudes in the support direction (the Y-axis direction). As illustrated in FIG. 6, the roll body R2 can be placed on the medium placement portion 101. Thus, in the printing apparatus 1 of the embodiment, when the roll body R2 is removed from the winding unit 6, the roll body R2 can be placed temporarily on the medium placement portion 101 of the medium reception unit 100. Further, as illustrated in FIG. 6, the medium reception unit 100 is held by the stay 61. Thus, in this state, a movement distance L1 of the roll body R2 is short, and the roll body R2 can easily be placed on the medium placement portion 101. Therefore, the printing apparatus 1 of the embodiment is configured so that the burden of work for removing the roll body R2 can be alleviated while suppressing an increase in size. Further, as a matter of course, when the medium reception unit 100 thus configured is provided, direct contact of the roll body R2 with an installation surface G can be suppressed, and contamination of the roll body R2 due to contact between the roll body R2 and the installation surface G can also be suppressed.

The configuration in which the medium reception unit 100 includes the medium placement portion 101 on which the roll body R2 can be placed is particularly advantageous in a printing apparatus whose height in the vertical direction is suppressed. With regard to this point, description is given below while comparing FIG. 2 and FIG. 3 with FIG. 8 and FIG. 9. As described above, in order to suppress the height of the printing apparatus 1 of the embodiment in the vertical direction, the stay 61 supports the winding unit 6 in the horizontal direction. Thus, as illustrated in FIG. 2 and FIG. 3, a height H1 of the printing apparatus 1 from the installation surface G to the distal end of the medium support portion 3B, which corresponds to a height of a portion from which the roll body R2 is removed, is lowered. In contrast, in the printing apparatus 50 in the reference example illustrated in FIG. 8 and FIG. 9, the stay 61 supports the winding unit 6 in the vertical direction. Thus, a height H2 of the printing apparatus 50 from the installation surface G to the distal end of the medium support portion 3B, which corresponds to a height of a portion from which the roll body R2 is removed, is higher.

When the height of the portion from which the roll body R2 is removed is high as in the printing apparatus 50 in the reference example illustrated in FIG. 8 and FIG. 9, a worker can remove the roll body R2 without feeling a significant work load. In contrast, when the height of the portion from which the roll body R2 is removed is low as in the printing apparatus 1 of the embodiment illustrated in FIG. 2 and FIG. 3, a worker is required to maintain a low posture for a long time period to remove the roll body R2. Thus, a work load tends to be significant. In view of this, in the printing apparatus 1 of the embodiment, a work load is alleviated by providing the medium reception unit 100 configured as described above.

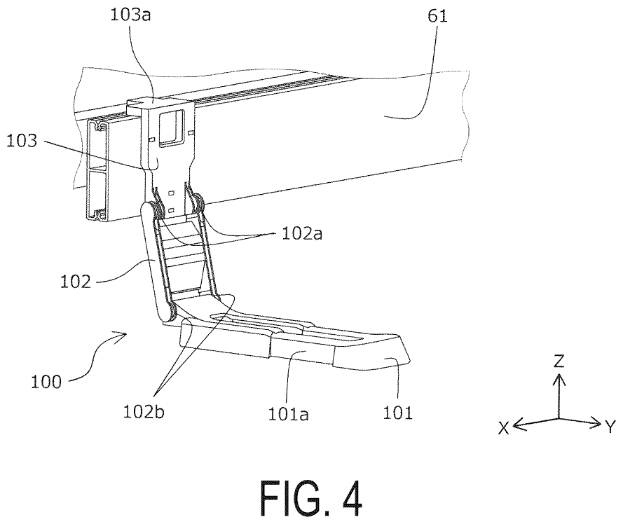

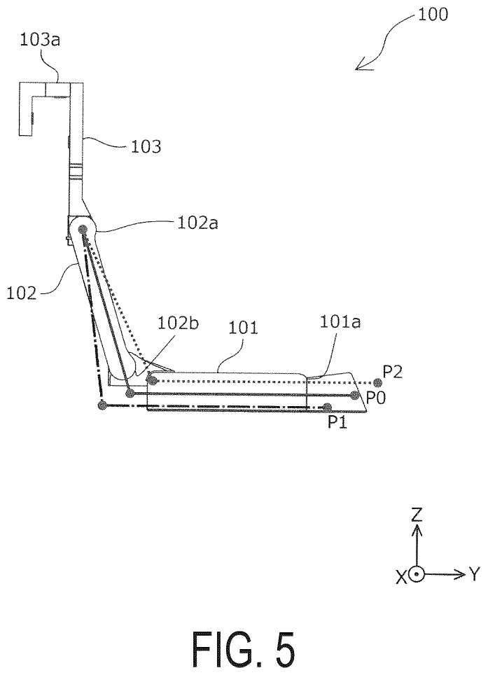

Next, an embodiment of the medium reception unit 100 that can be attached to the printing apparatus 1 of the embodiment is described below. As illustrated in FIG. 4, FIG. 5, and the like, the medium reception unit 100 of the embodiment is configured to include an engagement portion 103 that is engaged with the stay 61, and an intermediate portion 102 that is arranged between the engagement portion 103 and the medium placement portion 101, in addition to the medium placement portion 101. With this configuration, the medium reception unit 100 configured so that the roll body R2 can easily be placed on the medium placement portion 101 can be achieved.

Note that, as illustrated in FIG. 2, FIG. 3, FIG. 6, and the like, in the printing apparatus 1 of the embodiment, when the roll body R2 is removed from the winding unit 6, the medium placement portion 101 is installed on the installation surface G of the printing apparatus 1. Thus, there is achieved a configuration in which the medium reception unit 100 is not damaged even when the heavy roll body R2 is placed on the medium placement portion 101.

Specifically, the engagement portion 103 and the intermediate portion 102 are coupled at a joint portion 102a to be turnable about an axis parallel to the extension direction (the X-axis direction) of the stay 61, and the intermediate portion 102 and the medium placement portion 101 are coupled at a joint portion 102b to be turnable about an axis parallel to the extension direction of the stay 61. With this, in the printing apparatus 1 of the embodiment, the medium placement portion 101 is in a state of being installed on the installation surface G of the printing apparatus 1. With this configuration, when the roll body R2 is placed on the medium placement portion 101, the medium placement portion 101 can be arranged suitably so that installation on the installation surface G is achieved. Further, when the roll body R2 is not scheduled to be placed on the medium placement portion 101, the medium placement portion 101 can be folded upward at the joint portion 102a and the joint portion 102b, and the medium placement portion 101 can be arranged at a position that does not interfere with a worker.

As described above, the medium reception unit 100 of the embodiment can change the arrangement of the intermediate portion 102 with respect to the engagement portion 103 at the joint portion 102a and the arrangement of the medium placement portion 101 with respect to the intermediate portion 102 at the joint portion 102b. Specifically, as illustrated in FIG. 5, the arrangement of the center position of the intermediate portion 102 and the medium placement portion 101 in a side view can be changed from a position P1, which is indicated by the one-dot chain line, to a position P2, which is indicated by the broken line, with respect to a reference position PO, which is indicated by the solid line.

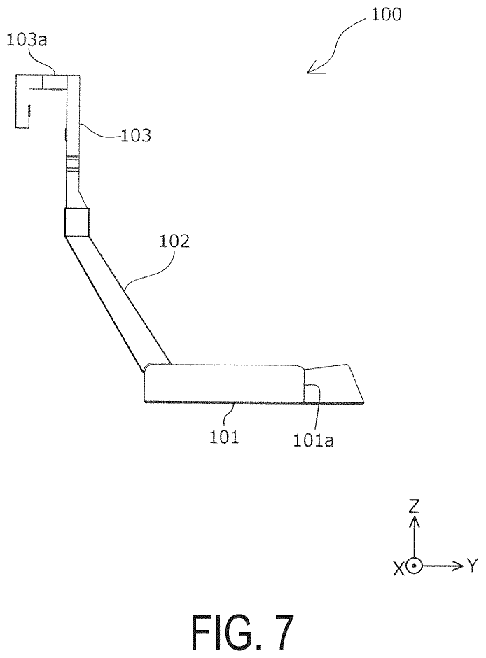

However, the medium reception unit 100 is not limited to such a configuration. For example, as illustrated in FIG. 7, a configuration in which the intermediate portion 102 is directly fixed to the engagement portion 103 and the medium placement portion 101 without a joint portion or the like may be adopted, and the intermediate portion 102 may be configured by a flexible member. Also, with this configuration, the medium placement portion 101 can be in a state of being installed on the installation surface G of the printing apparatus 1, a strong force can be deflected when the force is applied to the medium reception unit 100, and damage of the medium reception unit 100 can be suppressed. Note that, in the medium reception unit 100 in FIG. 7, the intermediate portion 102 is configured by an elastic member formed of rubber. The intermediate portion 102 may be configured by fabric, or the intermediate portion 102 may be configured by an elastic member such as a coil spring.

Herein, as illustrated in FIG. 3, the medium reception unit 100 of the embodiment includes two units, specifically, a medium reception unit 100A and a medium reception unit 100B. Those units are both configured to be movable in the X-axis direction being an extension direction thereof with respect to the stay 61. The printing apparatus 1 of the embodiment is thus configured. With this, the medium reception unit 100 can be arranged with respect to the stay 61 according to the medium M with various widths (lengths in the axial line direction), and the burden of work for removing the roll body R2 can be alleviated.

There is no limitation for the configuration in which the medium reception unit 100 is movable in the extension direction with respect to the stay 61. However, as illustrated in FIG. 4 and FIG. 5, in the medium reception unit 100 of the embodiment, there is adopted a configuration in which the engagement portion 103 is engaged while being hooked in the vertical direction to the stay 61 via a hook portion 103a. The printing apparatus 1 of the embodiment is thus configured. With this, the medium reception unit 100 can be attached easily and securely to the stay 61.

Further, as understood from comparison of FIG. 2 and FIG. 5 with FIG. 4 and FIG. 6, in the printing apparatus 1 of the embodiment, the medium placement portion 101 includes a drawer portion 101a, and is configured so that the length thereof in the support direction (the Y-axis direction) can be changed. The printing apparatus 1 of the embodiment is thus configured. With this, the length of the medium placement portion 101 in the support direction can be changed suitably according to the roll body R2 with various winding diameters to support the roll body R2 with various winding diameters.

Herein, an example of a procedure for removing the roll body R2 from the winding unit 6 is described. First, as illustrated in FIG. 6 and the like, the medium placement portion 101 is installed on the installation surface G of the printing apparatus 1. Subsequently, the length of the medium placement portion 101 in the support direction is changed according to the winding diameter of the roll body R2. When the winding diameter of the roll body R2 is large, the length of the medium placement portion 101 in the support direction is increased. When the winding diameter of the roll body R2 is small, the length of the medium placement portion 101 in the support direction is not made too long, or is not increased at all.

Then, as illustrated in FIG. 6, a state of a roll body R2a being a state in which the roll body R2 is attached to the winding unit 6 is shifted to a state of a roll body R2b being a state in which the roll body R2 is placed on the medium placement portion 101. In this state, the roll body R2 moves vertically downward (the-Z direction) by the movement distance L1. Then, from a state of the roll body R2b, the roll body R2 is rolled over in the +Y direction by a movement distance L2 to obtain a state of a roll body R2c. In other words, the roll body R2 is arranged at the distal end side of the medium placement portion 101. In a state of the roll body R2c, the roll body R2 is arranged on the +Y side with respect to the downstream medium support portion 3C. Thus, the roll body R2 can easily be removed from the medium placement portion 101.

The present disclosure is not limited to the embodiment described above, and can be realized in various configurations without departing from the spirit of the present disclosure. Further, technical characteristics in the embodiment corresponding to the technical characteristics in each form described in the SUMMARY can be substituted or combined appropriately to solve some or all of the above-described problems, or to achieve some or all of the above-described effects. Further, when the technical characteristics are not described as being essential in the present specification, the technical characteristics can be deleted as appropriate.

For example, in the embodiment described above, the medium reception unit 100 is provided at a position at which the roll body R2 attached to the winding unit 6 can be removed. However, the medium reception unit 100 may be provided to a position at which the roll body R1 can be removed, the roll body R1 being attached to the supply unit 2, for example, a stay provided to the supply unit 2 side can be removed. The downstream medium support portion 3C on the winding unit 6 side tends to be increased so as to dry ink ejected onto the medium M, and the height H1 of the printing apparatus 1 from the installation surface G to the distal end of the medium support portion 3B tends to be low. Thus, the medium reception unit 100 may be attached to the winding unit 6 side. However, the medium reception unit 100 configured as described above is small in size and has high performance, and may be attached to the supply unit 2 side as a matter of course.

What is claimed is:

1. A printing apparatus, comprising:
a printing unit configured to perform printing on a medium;
a winding unit configured to support a paper tube around which the medium is wound, so as to sandwich the paper tube in an axial line direction of the paper tube, and configured to wind the medium;
a stay provided to extend in an extension direction parallel to the axial line direction in which the winding unit supports the paper tube, and configured to support the winding unit in a support direction intersecting with a vertical direction and the extension direction; and
a medium reception unit held by the stay and configured to receive a roll body of the medium wound into a roll shape, the roll body being configured to be removed from the winding unit, wherein
the medium reception unit includes a medium placement portion protruding in the support direction, and
the medium placement portion is configured to allow the roll body to be placed thereon.

2. The printing apparatus according to claim 1, wherein
the medium reception unit includes an engagement portion engaged with the stay and an intermediate portion arranged between the engagement portion and the medium placement portion.

3. The printing apparatus according to claim 2, wherein
the engagement portion and the intermediate portion are coupled to be turnable about an axis parallel to the extension direction, and
the intermediate portion and the medium placement portion are coupled to be turnable about an axis parallel to the extension direction.

4. The printing apparatus according to claim 2, wherein
the intermediate portion is formed of a flexible member.

5. The printing apparatus according to claim 1, wherein
the medium reception unit is configured to move in the extension direction with respect to the stay.

6. The printing apparatus according to claim 1, wherein
the medium reception unit is engaged with the stay from the vertical direction.

7. The printing apparatus according to claim 1, wherein
a length of the medium placement portion in the support direction is configured to be changed.
